(19) United States
(12) Patent Application Publication
(10) Pub. No.: US 2015/0217629 A1
(43) Pub. Date: Aug. 6, 2015

(54) VEHICLE AIR CONDITIONER

(71) Applicant: CALSONIC KANSEI CORPORATION, Saitama-shi (JP)

(72) Inventor: Keisuke KAWANISHI, Saitama-shi (JP)

(73) Assignee: CALSONIC KANSEl CORPORATION, Saitama-shi (JP)

(21) Appl. No.: 14/612,619

(22) Filed: Feb. 3, 2015

(30) Foreign Application Priority Data
Feb. 4, 2014 (JP) 2014-019391
Jun. 23, 2014 (JP) 2014-127905

(51) Int. Cl. B60H 1/34; B60H 1/24

(52) U.S. Cl. CPC B60H 1/3414; B60H 1/241

(57) ABSTRACT

A vehicle air conditioner has a blowoff mode door provided at a position where a rear seat blast passage is branched into a vent blowoff passage and a foot blowoff passage, and the blowoff mode door has a main door portion and a sub-door portion. The blowoff mode door is displaced by rotation among positions: a full-closed mode position where both the blowoff passages are closed; a vent blowoff mode position where the vent blowoff passage is opened and the foot blowoff passage is closed; a foot blowoff mode position where the vent blowoff passage is closed and the foot blowoff passage is opened; and a bi-level position where both the blowoff passages are opened.

### BACKGROUND

1. Technical Field

The present invention relates to a vehicle air conditioner including a plurality of blowoff openings whose blowoff mode can be selected.

2. Related Art

Japanese Patent Application Publication No. 2001-138728 discloses, as a vehicle air conditioner including a plurality of blowoff openings whose blowoff mode can be selected, a vehicle air conditioner performing air conditioning for a front seat and a rear seat independently in a vehicle compartment. With reference to FIGS. 9A, 9B, 9C and 9D, such a vehicle air conditioner will be described.

As illustrated in FIGS. 9A, 9B, 9C and 9D, a rear seat blowoff portion of the vehicle air conditioner includes a vent blowoff passage 102 and a foot blowoff passage 103 that are branched at a downstream side of a rear seat blast passage 101, a vent door 104 for opening and closing the vent blowoff passage 102, and a foot door 105 for opening and closing the foot blowoff passage 103.

In a fully-closed mode illustrated in FIG. 9A, both the vent door 104 and the foot door 105 are disposed at closed positions. Conditioned air does not flow into the vent blowoff passage 102 and the foot blowoff passage 103 that are branched at the downstream side of the rear seat blast passage 101.

In a vent blowoff mode illustrated in FIG. 9B, the vent door 104 is disposed at an open position, and the foot door 105 is disposed at a closed position. The conditioned air flows through the vent blowoff passage 102 and blows off from the vent opening portion 106 to an upper portion of the rear seat in the vehicle compartment.

In a foot blowoff mode illustrated in FIG. 9C, the vent door 104 is disposed at a closed position, and the foot door 105 is disposed at an open position. The conditioned air flows through the foot blowoff passage 103 and blows off from a foot opening portion 107 to a lower portion of the rear seat in the vehicle compartment.

In a fully-opened mode illustrated in FIG. 9D, both the vent door 104 and the foot door 105 are disposed at open positions. The conditioned air flows through the vent blowoff passage 102 and the foot blowoff passage 103 to blow off further through the vent opening portion 106 and the foot opening portion 107 to the upper portion and the lower portion of the rear seat in the vehicle compartment. As described above, the two doors 104 and 105 are each opened and closed to realize four blowoff modes.

### SUMMARY

However, there has been a problem where, since the vehicle air conditioner illustrated in FIGS. 9A, 9B, 9C and 9D needs to be provided with the two doors 104, 105 to realize the four blowoff modes, the number of parts is increased and further a control system becomes more complicated, thereby increasing costs.

The present invention has been made in view of the above problem. An object of the present invention is to provide a vehicle air conditioner capable of reducing the number of parts, driving sources, and the costs.

One aspect of the present invention is a vehicle air conditioner comprising: a blast passage branched into a first blowoff passage and a second blowoff passage at a downstream side of the blast passage; and a blowoff mode door provided at a branch position of the first blowoff passage and the second blowoff passage, the first blowoff passage and the second blowoff passage, the blowoff mode door including: a main door portion configured to rotate about a rotation fulcrum; and a sub-door portion configured to integrally rotate with the main door portion, wherein the blowoff mode door is displaced by rotation among positions of: a full-closed mode position where the main door portion closes both the first blowoff passage and the second blowoff passage, a first blowoff mode position where the main door portion closes the second blowoff passage, and further the sub-door portion opens the first blowoff passage; a second blowoff mode position where the main door portion opens the second blowoff passage, and further the sub-door portion closes the first blowoff passage; and a third blowoff mode position where the main door portion opens both the first blowoff passage and the second blowoff passage, and further the sub-door portion opens both the first blowoff passage and the second blowoff passage.

Another aspect of the present invention may be a vehicle air conditioner in which a first blowoff passage is a vent blowoff passage for blowing off conditioned air to an occupant's upper body, a second blowoff passage is a foot blowoff passage for blowing off the conditioned air to the occupant's feet, a first blowoff mode position is a vent blowoff mode position, a second blowoff mode position is a foot blowoff mode position, and a third blowoff position is a bi-level blowoff mode position.

The sub-door portion may not fully close but may partially open the vent blowoff passage at the foot blowoff mode position.

The sub-door portion may be formed such that a door face of the sub-door portion extends along a flow direction of the conditioned air at the vent blowoff mode position.

The blast passage may be configured such that warm air and cool air flow in in front of the branch position of the vent blowoff passage and the foot blowoff passage, and the foot blowoff passage may be disposed at a position where the warm air flows in, and the vent blowoff passage may be disposed at a position where the cool air flows in.

The sub-door portion may be coupled to the main door portion by a coupling plate whose plate-thickness direction is set to an orthogonal direction of a blast direction.

The main door portion may include a first closing face portion and a second closing face portion each extending in a radial direction at a rotation angle of less than 180 degrees from a rotation fulcrum, and a center closing face portion connected with both the first closing face portion and the second closing face portion at the rotation fulcrum side of the first closing face portion and the second closing face portion, and coupled at a smaller angle than a rotation angle at the rotation fulcrum, at a position in front of the rotation fulcrum.

The main door portion and the sub-door portion may be formed separately, and then assembled.

The main door portion and the sub-door portion may be provided capable of being assembled at a plurality of assembly positions.

The vent blowoff passage and the foot blowoff passage may include those for the rear seat.

### BRIEF DESCRIPTION OF DRAWINGS

FIG. 1 is a schematic plan view illustrating an air conditioning unit according to a first embodiment of the present invention.

FIG. 2 is a cross-sectional view taken along the line II-II in FIG. 1.

FIG. 3 is a cross-sectional view taken along the line in FIG. 1.

FIG. 4A is a perspective view of a blowoff mode door according to the first embodiment.

FIG. 4B is a side view of the blowoff mode door according to the first embodiment.

FIG. 4C is a cross-sectional view of the blowoff mode door according to the first embodiment.

FIG. 5A is a cross-sectional view of an essential portion illustrating a full-closed mode of the air conditioning unit according to the first embodiment.

FIG. 5B is a cross-sectional view of the essential portion illustrating a vent blowoff mode of the air conditioning unit according to the first embodiment.

FIG. 5C is a cross-sectional view of the essential portion illustrating a foot blowoff mode of the air conditioning unit according to the first embodiment.

FIG. 5D is a cross-sectional view of the essential portion illustrating a bi-level blowoff mode of the air conditioning unit according to the first embodiment.

FIG. 6A is a cross-sectional view of an essential portion illustrating a full-closed mode of an air conditioning unit according to a second embodiment.

FIG. 6B is a cross-sectional view of the essential portion illustrating a vent blowoff mode of the air conditioning unit according to the second embodiment.

FIG. 6C is a cross-sectional view of the essential portion illustrating a foot blowoff mode of the air conditioning unit according to the second embodiment.

FIG. 6D is a cross-sectional view of the essential portion illustrating a bi-level blowoff mode of the air conditioning unit according to the second embodiment.

FIG. 7A illustrates a modification example of a blowoff mode door, and is a perspective view before a sub-door portion is assembled to a main door portion according to the first embodiment.

FIG. 7B illustrates a modification example of a blowoff mode door, and is a cross-sectional view when the sub-door portion is assembled to a first assembly portion according to the first embodiment.

FIG. 7C illustrates a modification example of a blowoff mode door, and is a cross-sectional view when the sub-door portion is assembled to a second assembly position according to the first embodiment.

FIG. 8A illustrates a modification example of a blowoff mode door, and is a cross-sectional view before a sub-door portion is assembled to a main door portion according to the second embodiment.

FIG. 8B illustrates a modification example of a blowoff mode door, and is a cross-sectional view when the sub-door portion is assembled to a first assembly position according to the second embodiment.

FIG. 8C illustrates a modification example of the blowoff mode door, and is a cross-sectional view when the sub-door portion is assembled to a second assembly position according to the second embodiment.

FIG. 9A is a configuration diagram of the essential portion illustrating a full-closed mode according to the prior art.

FIG. 9B is a configuration diagram of the essential portion illustrating a vent blowoff mode according to the prior art.

FIG. 9C is a configuration diagram of the essential portion illustrating a foot blowoff mode according to the prior art.

FIG. 9D is a configuration diagram of the essential portion illustrating a bi-level blowoff mode according to the prior art.

### DETAILED DESCRIPTION

Embodiments of the present invention will be described below with reference to the drawings.

### First Embodiment

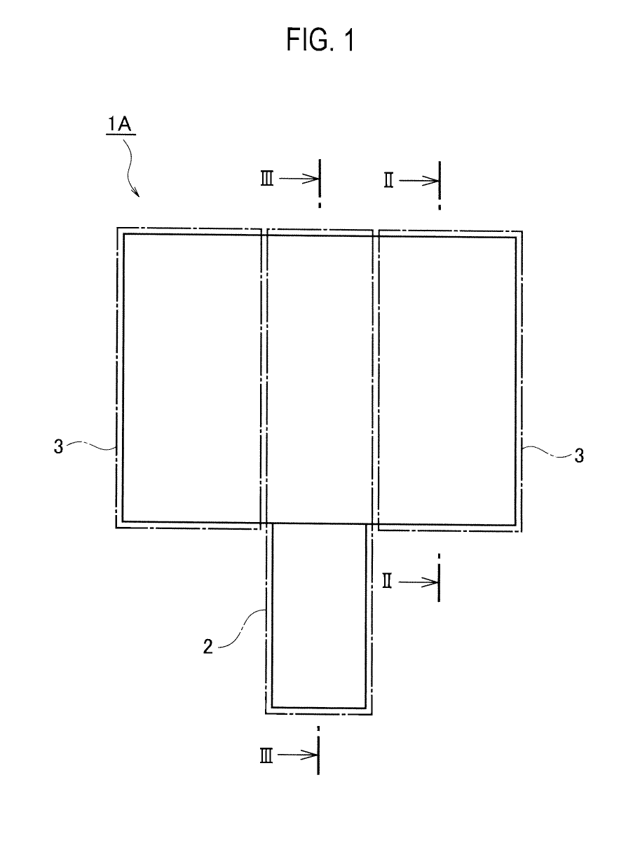

FIGS. 1, 2, 3, 4A, 4B, 4C, 5A, 5B, 5C and 5D illustrate a first embodiment of the present invention. As illustrated in FIG. 1, the vehicle air conditioner includes an air conditioning unit 1A disposed at a lower, inner side of an instrumental panel (not illustrated) of a vehicle. The air conditioning unit 1A includes a rear seat air conditioning unit 2 at a center portion in a width direction of the vehicle, and a right and left pair of front seat air conditioning units 3 at both sides of the rear seat air conditioning unit 2. Rear seat air conditioning is performed independently from front seat air conditioning in the vehicle (not illustrated).

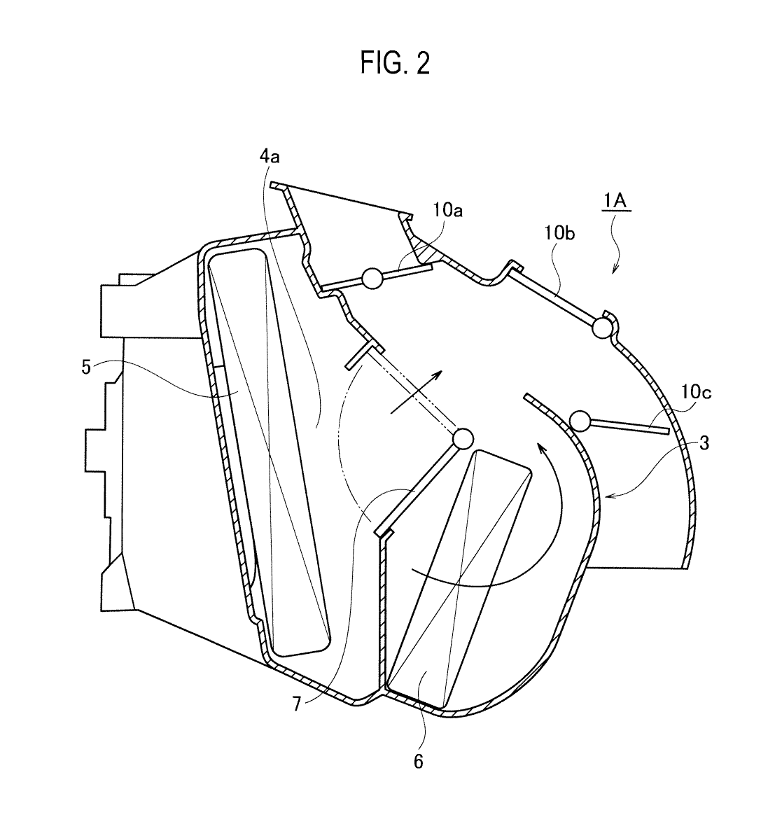

As illustrated in FIG. 2, the front-seat air conditioning unit 3 is provided with a pair of right and left front seat blast passages 4a. The front seat blast passage 4a is configured to suction inner air and outer air by a fan (not illustrated). An evaporator 5 and a heater core 6 are disposed passing through the front seat blast passage 4a. A front-seat mix door 7 is disposed at a downstream position of the evaporator 5, and further at an upstream position of the heater core 6 in the front seat blast passage 4a. The evaporator 5 is disposed to allow entire blast to pass through the front seat blast passage 4a to cool down the blast. The heater core 6 is disposed in a substantially half region of the front seat blast passage 4a to heat up the blast. The front-seat mix door 7 adjusts a ratio between blast flowing through the heater core 6 and blast bypassing the heater core 6. The conditioned air at a desired temperature is generated at a ratio of an amount of the air described above. At a more downstream side than an area where the blast flowing through the heater core 6 and the blast bypassing the heater core 6 merge each other, three blowoff doors 10a, 10b and 10c are disposed. When the blowoff doors 10a, 10b and 10c are opened and closed, a ratio of air distribution to the front seat defroster blowoff opening (not illustrated), a vent blowoff opening (not illustrated), and a foot blowoff opening (not illustrated) can be adjusted to realize a desired blowoff mode.

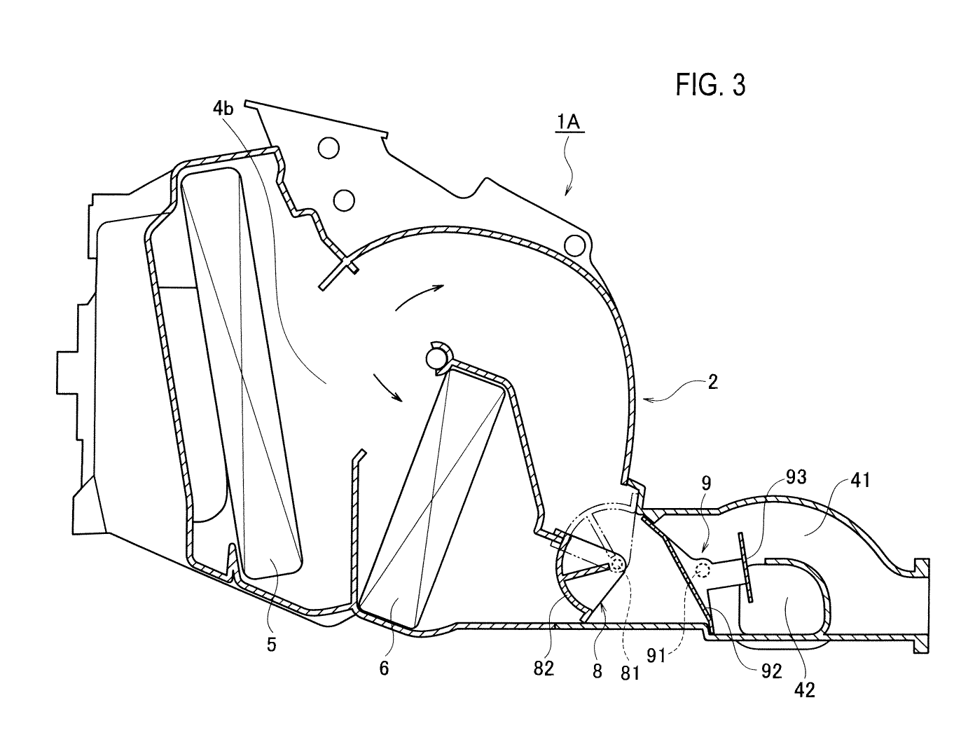

As illustrated in FIG. 3, the rear seat air conditioning unit 2 includes a rear seat blast passage 4b. The rear seat blast passage 4b is configured to suction the inner air and the outer air by the fan (not illustrated). The above-described evaporator 5 and heater core 6 are disposed passing through the rear seat blast passage 4b. A rear seat mix door 8 is disposed at a downstream position of the evaporator 5 and the heater core 6 in the rear seat blast passage 4b. The rear seat blast passage 4b includes a portion where the blasts merge at a downstream side of the rear seat mix door 8. At a further downstream side, the rear seat blast passage 4b is branched into a vent blowoff passage 41 (first blowoff passage) for blowing off the conditioned air to the occupant's upper body and a foot blowoff passage 42 (second blowoff passage) for blowing off the conditioned air to the occupant's feet. At the branch position described above, a blowoff mode door 9 is provided. At a position where a main stream of the cool air flows in, the vent blowoff passage 41 is disposed. At a position where a main stream of the warm air flows in, the foot blowoff passage 42 is disposed. The conditioned air passing through the vent blowoff passage 41 is blown off from the vent blowoff opening (not illustrated) to the occupant's upper body at the rear seat. The conditioned air passing through the foot blowoff passage 42 is blown off from the foot blowoff opening (not illustrated) to the occupant's feet at the rear seat.

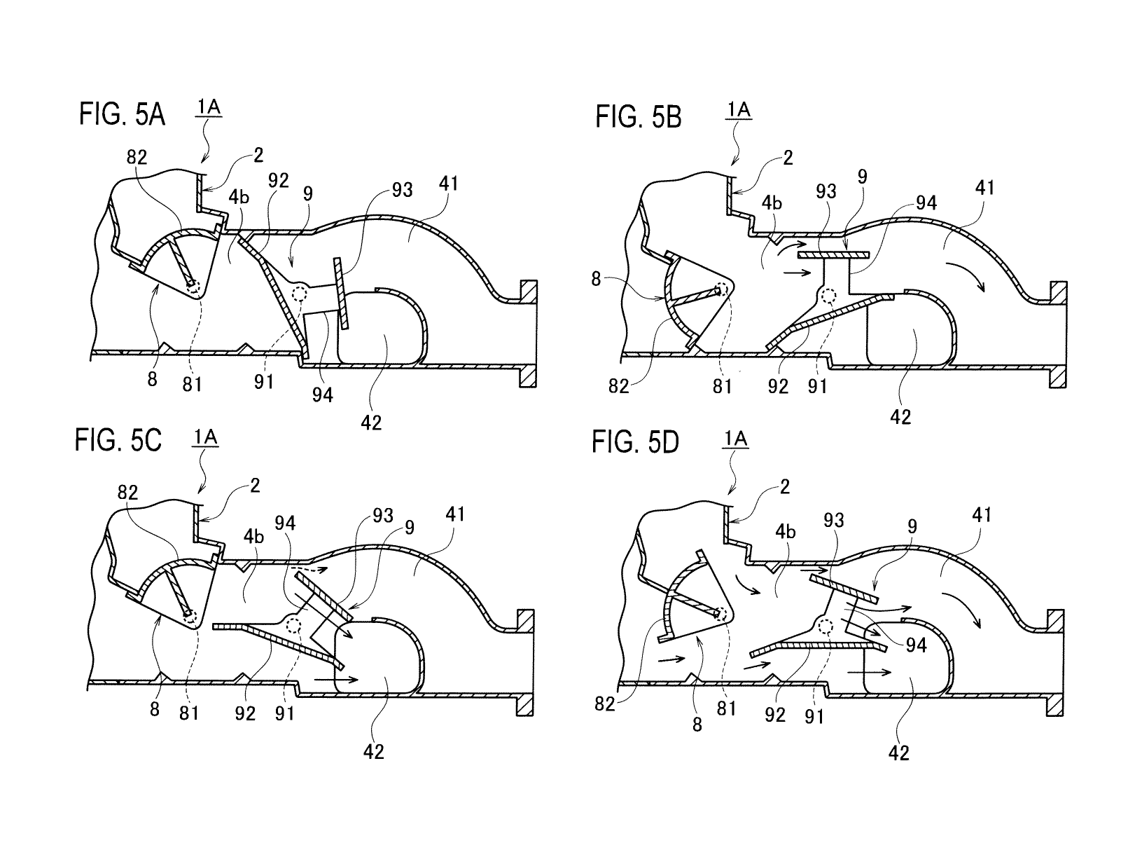

The rear seat mix door 8 includes a rotation fulcrum 81, and a closing face portion 82 rotating about the rotation fulcrum 81. The rear seat mix door 8 is displaced when the closing face portion 82 is rotated between a fully-cooling position illustrated in FIG. 5B and a fully-warming position illustrated in FIG. 5C, and adjusts a ratio between the blast flowing through the heater core 6 and the blast bypassing the heater core 6. The conditioned air at a desired temperature is generated at the ratio of the amount of the air described above, and supplied to the rear seat in the vehicle compartment.

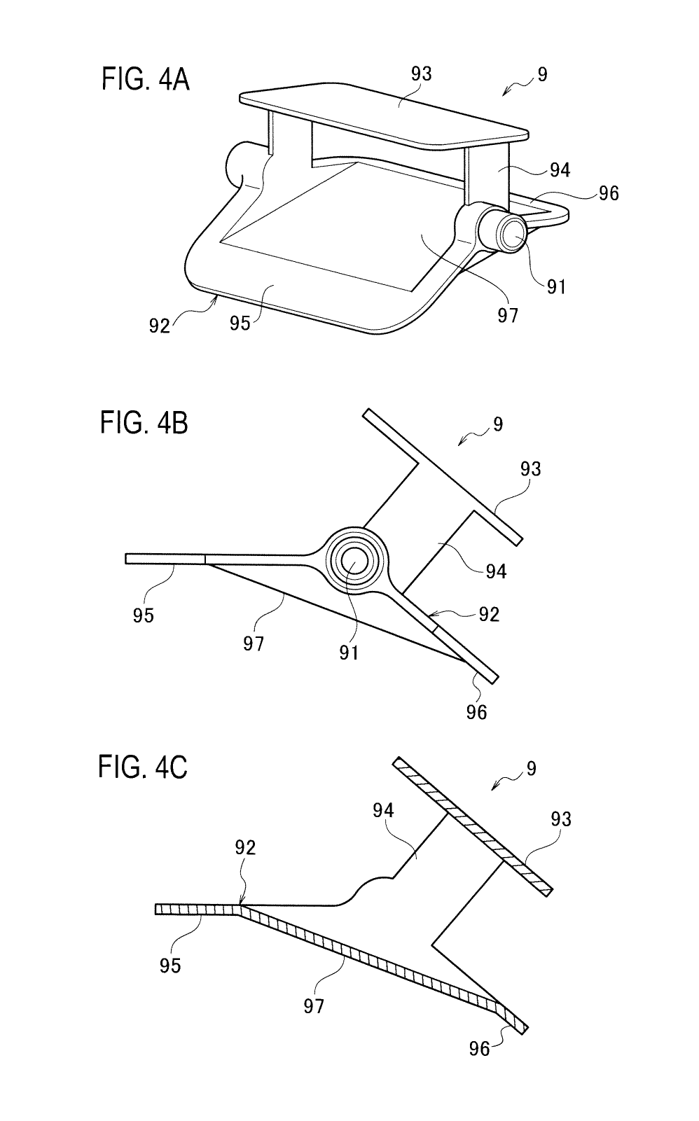

As illustrated in FIGS. 4A, 4B and 4C, the blowoff mode door 9 includes a main door portion 92 rotating about a rotation fulcrum 91, and a sub-door portion 93 rotating integrally with the main door portion 92. The main door portion 92 includes a first closing face portion 95 and a second closing face portion 96 each extending in a radial direction at a rotation angle of less than 180 degrees from the rotation fulcrum 91, and a center closing face portion 97 connected with both the first closing face portion 95 and the second closing face portion 96 at the rotation fulcrum 91 side of the first closing face portion 95 and the second closing face portion 96, and coupled at a smaller angle than a rotation angle at the rotation fulcrum 91, at a position in front of the rotation fulcrum 91. The sub-door portion 93 has a flat plate-like shape, and coupled with the main door portion 92 by a coupling plate 94. The thickness direction of the coupling plate 94 is set to the orthogonal direction of the blast direction. The blowoff mode door 9 is formed by an integral member using a single mold injection.

The blowoff mode door 9 is displaced by rotation among a full-closed mode position illustrated in FIG. 5A, a vent blowoff mode position (first blowoff mode position) illustrated in FIG. 5B, a foot blowoff mode position (second blowoff mode position) illustrated in FIG. 5C, and a bi-level blowoff mode position (third blowoff mode position) illustrated in FIG. 5D.

At the full-closed mode position illustrated in FIG. 5A, the main door portion 92 closes both the vent blowoff passage 41 and the foot blowoff passage 42.

At the vent blowoff mode position illustrated in FIG. 5B, the main door portion 92 closes the foot blowoff passage 42, and further the sub-door portion 93 opens the vent blowoff passage 41.

At the blowoff mode position illustrated in FIG. 5C, the main door portion 92 opens the foot blowoff passage 42, and further the sub-door portion 93 does not fully close but partially opens the vent blowoff passage 41.

At the bi-level blowoff mode position illustrated in FIG. 5D, the main door portion 92 opens both the vent blowoff passage 41 and the foot blowoff passage 42, and further the sub-door portion 93 opens both the vent blowoff passage 41 and the foot blowoff passage 42.

Operations of the rear seat air conditioning unit 2 of the vehicle air conditioner having the above-described configuration will be described. The outer air and the inner air are suctioned into the rear seat blast passage 4b by the fan (not illustrated). Suctioned air becomes the cool air after passing through the evaporator 5, and becomes the warm air after passing through the heater core 6. The cool air and the warm air are made into the conditioned air at the desired temperature when they are distributed by the rear seat mix door 8. For example, at the fully-cooling position, the rear seat mix door 8 entirely blocks the warm air that flows through the heater core 6, and only the cool air that has passed through the evaporator 5 is led to the downstream side. At the fully-warming position, the rear seat mix door 8 entirely blocks the cool air that has passed through the evaporator 5, and only the warm air that has passed through the heater core 6 is led to the downstream side.

In the full-closed mode illustrated in FIG. 5A, since the main door portion 92 of the blowoff mode door 9 is set at the position to close both the vent blowoff passage 41 and the foot blowoff passage 42, the conditioned air does not flow into the vent blowoff passage 41 and the foot blowoff passage 42.

In the vent blowoff mode illustrated in FIG. 5B, since the main door portion 92 is set at the position to close the foot blowoff passage 42, the conditioned air does not flow into the foot blowoff passage 42. On the other hand, the sub-door portion 93 does not block the vent blowoff passage 41, and the cool air flows through the vent blowoff passage 41 and blows off from the vent opening portion to the rear seat in the vehicle compartment.

In the foot blowoff mode illustrated in FIG. 5C, since the main door portion 92 is set at the position to open the foot blowoff passage 42, the conditioned air flows through the foot blowoff passage 42 and blows off from the foot opening portion to the rear seat in the vehicle compartment. Herein, since the sub-door portion 93 does not fully close but partially opens the vent blowoff passage 41, the conditioned air flows a little through the vent blowoff passage 41 and blows off from the vent opening portion to the rear seat in the vehicle compartment.

In the bi-level blowoff mode illustrated in FIG. 5D, since the main door portion 92 is set at the position to open the foot blowoff passage 42, and further the sub-door portion 93 is set at the position to open the vent blowoff passage 41, the conditioned air blows off from the foot opening portion to the rear seat in the vehicle compartment through the foot blowoff passage 42, and also blows off from the vent opening portion to the rear seat in the vehicle compartment through the vent blowoff passage 41. Herein, in the bi-level blowoff mode, the rear seat mix door 8 is often located at a middle position (middle between a fully-cooling position and a fully-warming position). Therefore, in front of the branch position between the vent blowoff passage 41 and the foot blowoff passage 42, after the warm air and the cool air flow in, the warm air mainly flows into the foot blowoff passage 42, and also the cool air mainly flows into the vent blowoff passage 41. With this arrangement, the warm air flows through the foot blowoff passage 42 and blows off from the foot opening portion to the rear seat in the vehicle compartment, and further the cool air flows through the vent blowoff passage 41 and blows off from the vent opening portion to the rear seat in the vehicle compartment.

As described above, the blowoff mode door 9 includes a main door portion 92 rotating about the rotation fulcrum 91 and a sub-door portion 93 integrally rotating with the main door portion 92. The blowoff mode door 9 is configured to be displaced by rotation among four positions: namely, the full-closed mode position where the main door portion 92 closes both the vent blowoff passage 41 and the foot blowoff passage 42; the vent blowoff mode position where the main door portion 92 closes the foot blowoff passage 42, and further the sub-door portion 93 opens the vent blowoff passage 41; the foot blowoff mode position where the main door portion 92 opens the foot blowoff passage 42 and further the sub-door portion 93 closes the vent blowoff passage 41; and the bi-level blowoff mode position where the main door portion 92 opens both the vent blowoff passage 41 and the foot blowoff passage 42 and the sub-door portion 93 opens both the vent blowoff passage 41 and the foot blowoff passage 42. Therefore, since four blowoff modes including the full-closed mode, the vent blowoff mode, the foot blowoff mode, and the bi-level blowoff mode can be realized by opening and closing with one blowoff mode door 9 the vent blowoff passage 41 and the foot blowoff passage 42 that are branched from each other at the downstream side of the rear seat blast passage 4b of the air conditioning unit 1A. Therefore, the number of the parts, the driving sources, and the costs can be reduced.

The sub-door portion 93 is configured not to fully close but partially opens the vent blowoff passage 41 at the foot blowoff mode position. Therefore, in the foot blowoff mode also, occupant's requests for preventing a window from mist in the vehicle compartment and preferring mild vent air can be realized.

At the vent blowoff mode position, a door face of the sub-door portion 93 is formed along a flow direction of the conditioned air. In this embodiment, the face in a flat plate-like shape of the sub-door portion 93 is set to be along the flow direction of the conditioned air. Therefore, since the sub-door portion 93 scarcely resists air blast, in the vent blowoff mode also, a similar amount of blowoff air to that in other modes can be ensured.

The rear seat blast passage 4b is configured such that the warm air and the cool air flow into the rear seat blast passage 4b in front of the branch position between the vent blowoff passage 41 and the foot blowoff passage 42. At a position where the warm air flows in, the foot blowoff passage 42 is disposed, and at a position where the cool air flows in, the vent blowoff passage 41 is disposed. Therefore, in the bi-level blowoff mode, the cool air mainly flows into the vent blowoff passage 41, and also the warm air mainly flows into the foot blowoff passage 42. Therefore, relatively cool air can be blown to the occupant's upper body on the rear seat, and relatively warm air can be blown to the occupant's lower body. As a result, since the occupant does not feel excessively cool or excessively warm, air conditioning that can damage health of the occupant can be prevented.

The sub-door portion 93 is coupled with the main door portion 92 by the coupling plate 94 whose plate-thickness direction is set to the orthogonal direction of the blast direction, and the face of the coupling plate 94 is configured to be along with the blast direction even when the sub-door portion 93 is rotated. Therefore, the coupling plate 94 can be prevented from resisting the air blast as much as possible.

The main door portion 92 includes a first closing face portion 95 and a second closing face portion 96 each extending in the radial direction at the rotation angle of less than 180 degrees from the rotation fulcrum 91, and the center closing face portion 97 where the first closing face portion 95 and the second closing face portion 96 are connected with each other at the rotation fulcrum 91 side of the first closing face portion 95 and the second closing face portion 96, and coupled with each other at the smaller angle than the rotation angle at the rotation fulcrum 91, at a position in front of the rotation fulcrum 91.

When the main door portion 92 does not include the above-described center closing face portion 97 but the blowoff mode door 9 has a configuration where the air flows into a vicinity of the rotation fulcrum 91, at the first closing face portion 95 and the second closing face portion 96, the vicinity of the rotation fulcrum 91 becomes a region like an air reservoir, and thus the blast does not flow smoothly. However, according to the present invention, since the center closing face portion 97 restricts the air from flowing into the vicinity of the rotation fulcrum 91, the region like an air reservoir is not generated around the blowoff mode door 9, and thus the blast smoothly flows around the blowoff mode door 9.

According to the embodiment described above, the vent blowoff passage 41 and the foot blowoff passage 42 are used for the rear seat in the vehicle compartment, but, of course, it may be provided to switch passages for other seats than the rear seat.

### Second Embodiment

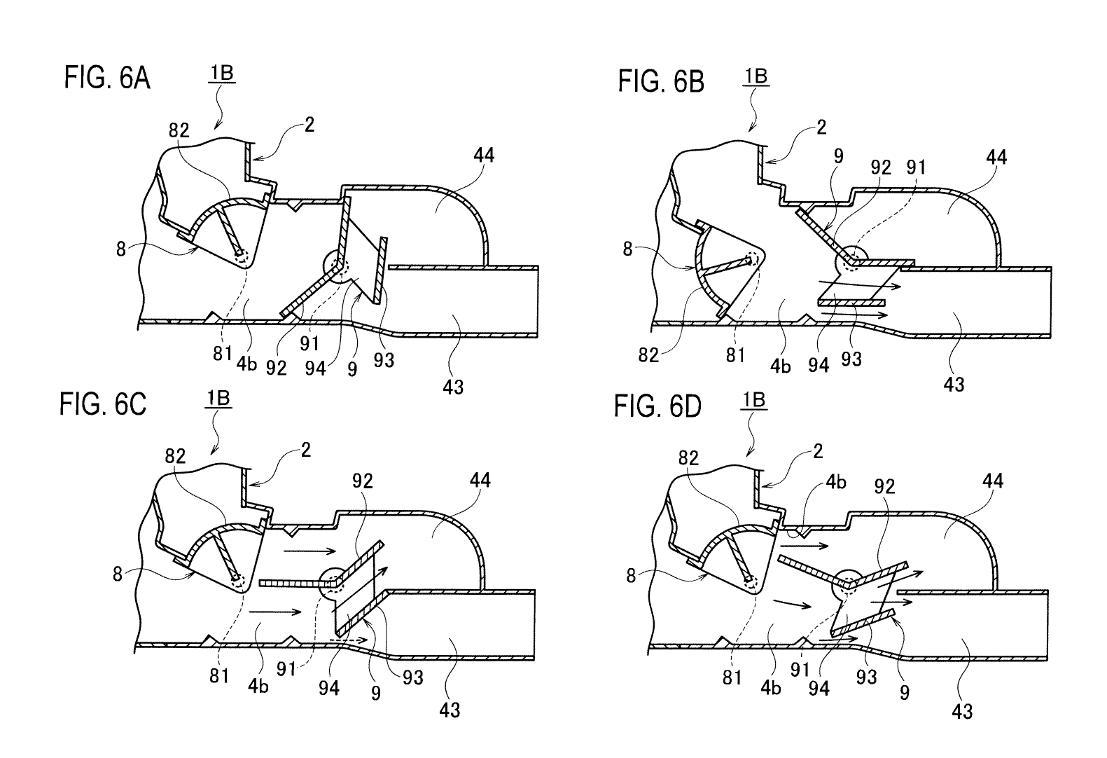

FIGS. 6A, 6B, 6C and 6D illustrate the second embodiment of the present invention. As illustrated in FIGS. 6A, 6B, 6C and 6D, the vehicle air conditioner of the second embodiment is different from that in the first embodiment in that the air conditioning unit 1B includes the vent blowoff passage 43 (first blowoff passage) and the foot blowoff passage 44 (second blowoff passage) that have different configurations from each other.

The rear seat blast passage 4b of the air conditioning unit 1B is branched into the vent blowoff passage 43 for blowing off the conditioned air to the occupant's upper body and the foot blowoff passage 44 for blowing off the conditioned air to the occupant's feet at the downstream side of the rear seat mix door 8. At the branch position, the blowoff mode door 9 is provided. The vent blowoff passage 43 is disposed at a lower side of the foot blowoff passage 44. Since other components are the same as those of the first embodiment, the description is not repeated to avoid redundancy. Further, at a portion having a same component as that of the first embodiment in the drawings, the same reference sign is applied for clarification.

In the second embodiment also, in a similar manner to the first embodiment, since four blowoff modes including a full-closed mode, a vent blowoff mode, a foot blowoff mode, and a bi-level blowoff mode can be realized, the number of the parts, the driving sources, and the costs can be reduced. Further, similar effects of other functions to that of the first embodiment can be obtained.

### [Modification Example of Blowoff Mode Door According to First Embodiment]

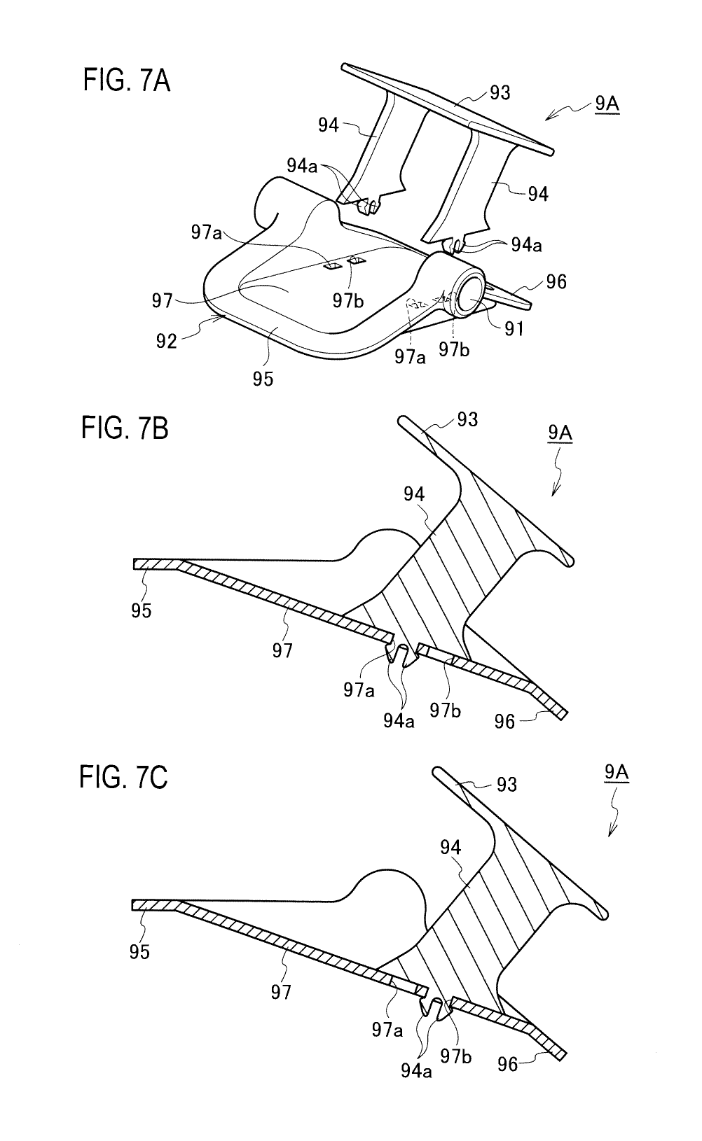

FIGS. 7A, 7B and 7C illustrate a blowoff mode door 9A according to a modification example of the first embodiment. In the blowoff mode door 9A of the modification example, as illustrated in FIG. 7A, the main door portion 92 and the sub-door portion 93 are formed separately. At right and left positions of the center closing face portion 97 of the main door portion 92, a first assembly hole 97a and a second assembly hole 97b are formed. A right and left pair of the first assembly hole 97a and the second assembly hole 97b are disposed at positions shifted from each other in the blast direction, and further at positions on a straight line along the blast direction.

The sub-door portion 93 is provided with a pair of coupling plate portions 94. On a leading end face of each coupling plate 94, one of a pair of engagement nails 94a is protrudingly provided. The pair of engagement nails 94a are formed such that the width dimension thereof can be contracted by elastically-warping deformation. The sub-door portion 93 can be selectively assembled to the first assembly hole 97a and the second assembly hole 97b by warping and deforming the pair of engagement nails 94a.

In the blowoff mode door 9A of the modification example, the main door portion 92 and the sub-door portion 93 are separate members. Therefore, when either one of the main door portion 92 and the sub-door portion 93 is changed in its shape, an entire blowoff mode door 9A does not need to be changed. In other words, when the sub-door portion 93 is changed in its shape, only the sub-door portion 93 may be changed. When the main door portion 92 is changed in its shape, only the main door portion 92 may be changed. Further, when the injection molding is performed with a die, compared to the integral blowoff mode door 9, the blowoff mode door 9A including the main door portion 92 and the sub-door portion 93 formed separately has a simpler injection molding body. Therefore, it may not be considered to provide a slope for die cutting.

As illustrated in FIG. 7B, when the sub-door portion 93 is assembled to the first assembly hole 97a (first assembly position), a leading end face of the sub-door portion 93 is positioned forward. As illustrated in FIG. 7C, when the sub-door portion 93 is assembled to the second assembly hole 97b (second assembly position), a leading end face of the sub-door portion 93 is positioned backward. With this arrangement, at the first assembly position illustrated in FIG. 7B, the leading end face of the sub-door portion 93 is positioned forward, and thus a small amount of air is leaked in the vent blowoff mode. At the first assembly position illustrated in FIG. 7C, the leading end face of the sub-door portion 93 is positioned backward, and thus a large amount of air is leaked in the vent blowoff mode. As described above, the sub-door portion 93 is provided to be capable of being assembled at the two assembling positions, and the assembly position can be changed to adjust the amount of the air leakage in the vent blowoff mode.

As illustrated in FIGS. 7B and 7C, when the sub-door portion 93 is assembled to the first assembly hole 97a, the coupling plate 94 provided to the sub-door portion 93 closes the second assembly hole 97b. When the sub-door portion 93 is assembled to the second assembly hole 97b, the coupling plate 94 provided to the sub-door portion 93 closes the first assembly hole 97a. Therefore, another operation is not needed for closing one of the assembly holes 97a, 97b that are not used. Further, three or more assembly holes can be provided, and an assembly operation can be performed at three or more positions.

Only a single assembly hole may be formed at the main door portion 92, and the sub-door portion 93 to be assembled to the sub-door portion 93 may be selected from among a plural types of the sub-door portions 93 to be assembled. Air blast variation can be changed by the configuration described above.

Same reference signs are applied to same portions as those of the first embodiment illustrated in FIGS. 7A, 7B and 7C, and the description will not be repeated.

### [Modification Example of Blowoff Mode Door According to Second Embodiment]

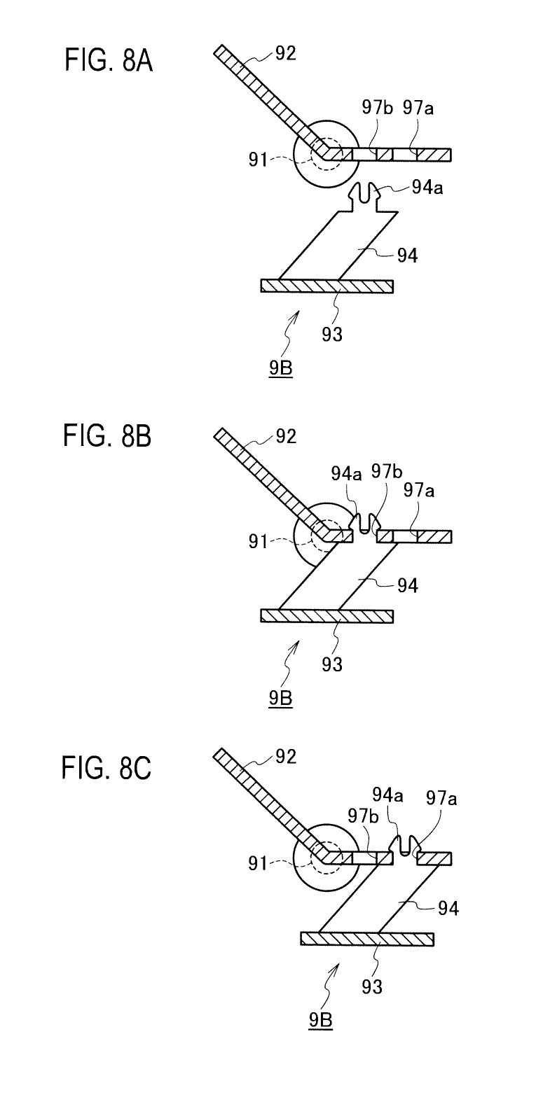

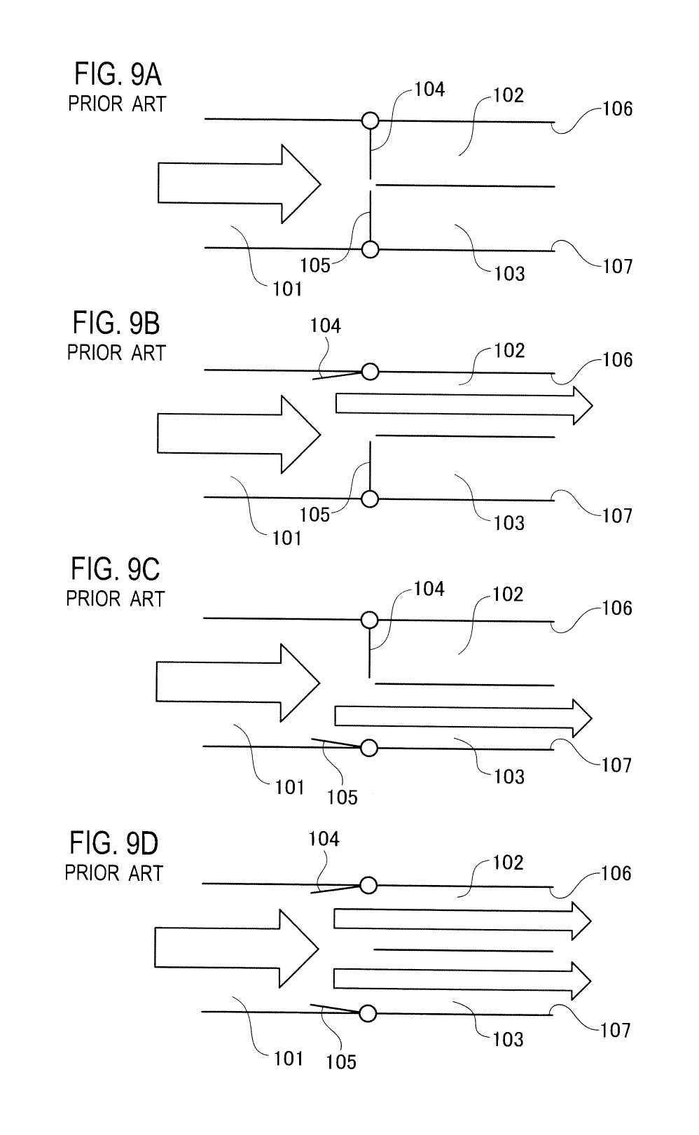

FIGS. 8A, 8B and 8C illustrate the blowoff mode door 9B according to the modification example of the second embodiment. As illustrated in FIG. 8A, the blowoff mode door 9B according to the modification example of the second embodiment includes the main door portion 92 and the sub-door portion 93 formed separately, in a similar manner to the modification example of the first embodiment illustrated in FIGS. 7A, 7B and 7C. Since other components are the same as those of the modification examples illustrated in FIGS. 7A, 7B and 7C, the same signs are applied to the drawings and the description will not be repeated.

As to the blowoff mode door 9B of the modification example described above, in a similar manner to the blowoff mode door 9A illustrated in FIGS. 7A, 7B and 7C, the main door portion 92 and the sub-door portion 93 are the separate members. Therefore, when any one of the main door portion 92 and the sub-door portion 93 is changed in its shape, the entire blowoff mode door 9B does not need to be changed. Further, when the injection molding is performed with the die, compared to the blowoff mode door 9 including the integrally formed main door portion 92 and sub-door portion 93, the blowoff mode door 9B including the main door portion 92 and the sub-door portion 93 formed separately has a simpler injection molding body. Therefore, it may not be considered to provide a slope for die cutting.

In a similar manner to the blowoff mode door 9A illustrated in FIGS. 7A, 7B and 7C, the blowoff mode door 9B is provided to be capable of being assembled at two assembly positions (assembly position illustrated in FIG. 8B, assembly position illustrated in FIG. 8C). When the assembly position is changed, the amount of air leakage in the vent blowoff mode can be adjusted.

### Modification Examples of First and Second Embodiments

According to the first and second embodiments, in the foot blowoff mode, the sub-door portion 93 may be located at a position where the sub-door portion 93 does not fully close but partially opens the vent blowoff passage 41, or a position where it fully closes the vent blowoff passage 41.

According to the first and second embodiments, a vehicle air conditioner is described that independently performs air conditioning for the front seat and the rear seat in the vehicle compartment (when the air conditioning is performed for three seats independently), but, the present invention is not limited to the vehicle air conditioner described above. The present invention can be adopted to a vehicle air conditioner performing air conditioning for two rear seats independently in the vehicle compartment (when the air conditioning is performed for four seats independently), as a modification example.

As described above, the present invention is described using the preferable embodiments of the present invention. Herein, the present invention is described showing the specific examples, but various corrections and changes can be made on the specific examples without departing from the scope and the spirit of the present invention defined in the claims.

The present application claims the priority based on Japanese Patent Application No. 2014-019391 filed on the 4 Feb. 2014 and Japanese Patent Application No. 2014-127905 filed on the 23 Jun. 2014, the entire contents of which are incorporated herein by reference.

### INDUSTRIAL APPLICABILITY

According to the present invention, since four blowoff modes can be realized by opening and closing a first blowoff passage and a second blowoff passage that are branched from each other at the downstream side of the blast passage with one blowoff mode door, the number of parts, the driving sources, and the costs can be reduced.

### REFERENCE SIGNS LIST

4b rear seat blast passage (blast passage)
9 blowoff mode door
41, 43 vent blowoff passage (first blowoff passage)
42, 44 foot blowoff passage (second blowoff passage)
91 rotation fulcrum
92 main door portion
93 sub-door portion
94 coupling plate
95 first closing face portion
96 second closing face portion
97 center closing face portion

What is claimed is:

1. A vehicle air conditioner comprising: a blast passage branched into a first blowoff passage and a second blowoff passage at a downstream side of the blast passage; and a blowoff mode door provided at a branch position of the first blowoff passage and the second blowoff passage, the first blowoff passage and the second blowoff passage,
the blowoff mode door including: a main door portion configured to rotate about a rotation fulcrum; and a sub-door portion configured to integrally rotate with the main door portion, wherein
the blowoff mode door is displaced by rotation among positions of:
a full-closed mode position where the main door portion closes both the first blowoff passage and the second blowoff passage,
a first blowoff mode position where the main door portion closes the second blowoff passage, and further the sub-door portion opens the first blowoff passage;
a second blowoff mode position where the main door portion opens the second blowoff passage, and further the sub-door portion closes the first blowoff passage; and
a third blowoff mode position where the main door portion opens both the first blowoff passage and the second blowoff passage, and further the sub-door portion opens both the first blowoff passage and the second blowoff passage.

2. The vehicle air conditioner according to claim 1, wherein
the first blowoff passage is a vent blowoff passage for blowing off conditioned air to an occupant's upper body;
the second blowoff passage is a foot blowoff passage for blowing off conditioned air to occupant's feet;
the first blowoff mode position is a vent blowoff mode position;
the second blowoff mode position is a foot blowoff mode position; and
the third blowoff mode position is a bi-level blowoff mode position.

3. The vehicle air conditioner according to claim 2, wherein the sub-door portion does not fully close but partially opens the vent blowoff passage at the foot blowoff mode position.

4. The vehicle air conditioner according to claim 2, wherein the sub-door portion is formed such that a door face of the sub-door portion extends along a flow direction of the conditioned air at the vent blowoff mode position.

5. The vehicle air conditioner according to claim 2, wherein
the blast passage is configured such that warm air and cool air flow in in front of the branch position of the vent blowoff passage and the foot blowoff passage are branched from each other; and
the foot blowoff passage is disposed at a position where the warm air flows in, and the vent blowoff passage is disposed at a position where the cool air flows in.

6. The vehicle air conditioner according to claim 2, wherein the sub-door portion is coupled with the main door portion by a coupling plate whose plate-thickness direction is set to an orthogonal direction of a blast direction.

7. The vehicle air conditioner according to claim 1, wherein
the main door portion includes:
a first closing face portion and a second closing face portion each extending in a radial direction at a rotation angle of less than 180 degrees from the rotation fulcrum;
a center closing face portion connected with both the first closing face portion and the second closing face portion at the rotation fulcrum side of the first closing face portion and the second closing face portion, and coupled at a smaller angle than a rotation angle at the rotation fulcrum, at a position in front of the rotation fulcrum.

8. The vehicle air conditioner according to claim 1, wherein the main door portion and the sub-door portion are formed separately and assembled.

9. The vehicle air conditioner according to claim 8, wherein the main door portion and the sub-door portion are provided capable of being assembled at a plurality of assembling positions.

10. The vehicle air conditioner according to claim 1, wherein the first blowoff passage and the second blowoff passage are used for a rear seat.
